(19) United States
(12) Patent Application Publication
(10) Pub. No.: US 2007/0033404 A1
(43) Pub. Date: Feb. 8, 2007

(54) System and method for the secure recognition of a network device

(75) Inventors: Costin Cozianu, Torrance, CA (US); George Koppich, Palos Verdes Estates, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Toshiba Corporation; Toshiba Tec Kabushiki Kaisha

(21) Appl. No.: 11/197,107

(22) Filed: Aug. 4, 2005

(51) Int. Cl. H04L 9/00

(52) U.S. Cl. 713/171

(57) ABSTRACT

A system and method for the secure recognition of network devices. The method begins with the receiving of a first communication via a first communication network. The first communication includes identification data representing a network device to be added to a selected network. In response to the identification data, a first data key associated with an initial login of the network device is transmitted and entered into the network device. The identification data entered into the network device is validated and upon validation, the network device is connected so as to enable it for initial data communication via a second network. Via the second network, the network device receives a second data key, which enables the network device for further data communication via the second network.

### BACKGROUND

This invention is directed to a system and method for recognizing network devices. More particularly, this invention is directed to a system and method for securely recognizing network devices.

In large computer networks, such as wide area networks, new devices are constantly added to the network. These devices include, for example, document processing devices, personal computers, mobile electronic devices and the like. To maintain data security and network integrity, each of these devices must be recognized by the network. Recognition typically involves a unique password or identification being validated by an administrative device or system resident on the network. However, difficulties arise in getting the unique password or identification to the new device securely, particularly when the wide area network is dispersed geographically. In addition, merely including the unique password or identification internally with the device does not solve this problem, but rather compromises the security of the wide area network in the event the network device is stolen or misplaced.

Thus there is a need for a system and method for securely recognizing the addition of a network device to an existing network.

### SUMMARY OF INVENTION

In accordance with the present invention, there is provided a system and method for network computing.

Still further, in accordance with the present invention, there is provided a system and method for the secure recognition of a network device.

Still further, in accordance with the present invention, there is provided a system for the secure recognition of a network device. The system includes receiving means adapted to receive a first communication. The first communication includes data representing a network device to be added to a selected network. The system also includes transmission means adapted to transmit in response to the identification data, a first data key associated with an initial login of the network device. The system further includes entry means adapted to enter the first key into the network device and validation means adapted to validate the identification data entered into the device. The system is then enabled for initial data communication via a second network using connection means following the validation of the first key. The system also comprises receiving means adapted to receive a second data key over the second network and enabling means adapted to enable the network device for further data communication via the second network upon receipt of the second data key.

Still further, in accordance with the present invention, there is provided a method of secure recognition of a network device. The method begins with the receiving of a first communication via a first communication network. The first communication includes identification data representing a network device to be added to a selected network. In response to the identification data, a first data key associated with an initial login of the network device is transmitted and entered into the network device. The identification data entered into the network device is validated and upon validation, the network device is connected so as to enable it for initial data communication via a second network. Via the second network, the network device receives a second data key, which enables the network device for further data communication via the second network.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description, serve to explain the principles of the invention.

FIG. 1 is a block diagram illustrating a system in accordance with the present invention; and

FIG. 2 is a flow chart illustrating a token generation method in accordance with the present invention.

### DETAILED DESCRIPTION OF THE EMBODIMENTS

The present invention is directed to a system and method for recognizing network devices. More particularly, the present invention is directed to a system and method for securely recognizing network devices.

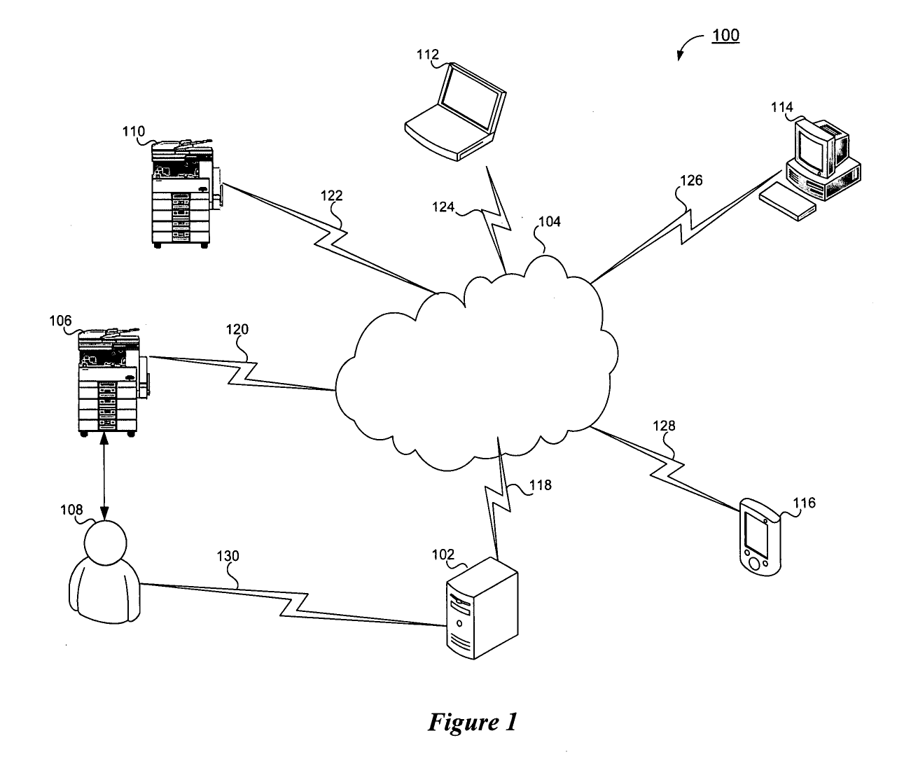

Turning now to FIG. 1, there is shown a diagram illustrating a system 100 in accordance with the present invention. As depicted in FIG. 1, a backend unit 102 suitably facilitates the administration of a computer network 104. The backend unit 102 is illustrated in FIG. 1 as a single server, however those skilled in the art will appreciate that multiple backend devices are equally capable of being implemented to manage and administer the computer network 104 and the single unit 102 is suitably used herein for ease of explanation only. Preferably, the backend unit 102 is a server suitably adapted to communicate with the computer network 104 via a communications link 118. More preferably, the backend unit 102 is representative of a services provider, facilitating the administration of the computer network 104, including, for example and without limitation, support devices, support personnel, administrative personnel, and the like. As will be understood by those skilled in the art, the communications link 118 is any suitable means of communication between two electronic devices. Suitable communications means include, but are not limited to, the Internet, an Ethernet based local area network or wide area network connection, an infrared connection, a Bluetooth connection, a Wi-Fi connection, an IEEE 802.11(x) connection, a telephonic connection, a cellular based connection, and the like, or a combination thereof. Preferably, the backend unit 102 communicates with the computer network 104 via the Internet.

As will be understood by those skilled in the art, the computer network 104 is capable of being a wide area network, a local area network, the Internet, an intranet, and the like. In the preferred embodiment, the implementation of the computer network 104 is advantageously accomplished via a wide area network, such that multiple devices in a variety of geographical locations are suitably connected to the network 104. More preferably, the computer network 104 is a secure data network, protected from unauthorized access by any means known in the art, including, with limitation, a firewall. As illustrated in FIG. 1, the computer network 104 is in data communication with a variety of network devices, shown in FIG. 1 as a document processing device 110, a laptop computer 112, a personal computer 114, and a personal data assistant 116. The skilled artisan will appreciate that other personal electronic devices are equally capable of being connected to the computer network 104 as are known in the art, as well as non-personal, e.g., business-based systems.

Each of the network devices 110-116 suitably communicate with the computer network 104 via a corresponding communications link, illustrated as 122, 124, 126, andl28, respectively. As will be understood by those skilled in the art, the communications links 122-128 are any communications means known in the art suitable for communication between two electronic devices. Such communications means include, but are not limited to, an Ethernet-based local area network, a wide area network, an IEEE 802.11(x) wireless connection, a Wi-Fi connection, an infrared connection, the Internet, a Bluetooth connection, a cellular-based connection, and the like, or any combination thereof. Preferably, the network devices 110-116 suitably interact with the backend unit 102 via the computer network 104 behind a firewall, e.g., secure data communications. It will further be appreciated that the each one of the various network devices 110-116 are advantageously capable of employing one or more communications means which differ from any of the other network devices. Thus, for example and without limitation, the laptop computer 112 communicates with the computer network 104 via an IEEE 802.11(x) wireless connection 124, the personal computer 114 communicates with the computer network 104 via an Ethernet-based wired connection 126, and the personal data assistant 116 communicates with the computer network 104 via a Bluetooth wireless connection 128. It will further be understood by those skilled in the art that although not shown in FIG. 1, the computer network 104 suitably includes one or more electronic components necessary to receive and transmit data via any of the communications means known in the art.

As will be understood by those skilled in the art, the addition of a new network device, shown in FIG. 1 as the document processing device 106, requires additional measures to access the secure computer network 104. It will be appreciated by those skilled in the art that the document processing device 106 is any suitable document processing device known in the art, including, without limitation, a facsimile machine, a scanner, a printer, a copier, a multifunction peripheral, and the like, or any combination thereof. Suitable commercially available document processing devices include, but are not limited to, the Toshiba e-Studio Series Controller. In accordance with the present invention, when adding the new network device 106, a user 108 is required to contact the backend unit 102 via a suitable communications link 130, prior to connecting the device 106 to the computer network 104. For example, the computer network 104 suitably represents a wide area network that provides cost-based services, such as document processing and data management services, to a variety of clients. One or more document processing devices are advantageously implemented as standalone kiosks, capable of providing document processing services to other devices via the computer network 104 or to users physically present at the kiosks. In this example, the backend unit 102 suitably includes financial data, document data, personnel, and the like, for the administration of the services and network 104. The skilled artisan will appreciate that in the foregoing example, the addition of one or more new network devices necessarily requires secure recognition so as to avoid misappropriation of data and financial information.

Preferably, the user 108 is a service technician or other authorized individual associated with the backend unit 102. More preferably, the communications link 130 is a voice-capable communications link enabling the technician 108 and an administrator or other service personnel at the backend unit 102 to communicate. For example, the communications link 130 is capable of being a public switched telephone network link, a voice-over-Internet-protocol link, a cellular-telephone link, and the like. It will further be appreciated by those skilled in the art that data only communications or data/voice communications, such as the Internet, are equally capable of facilitating transmissions between the technician 108 and the backend unit 102. In accordance with the present invention, the communications link 130 advantageously is established outside the computer network 104. Preferably, the technician 108 and the backend unit 102 communicate over the communications link 130 outside the firewall or other security implementation that secures the computer network 104 from intrusion by unauthorized users and devices.

When the new network device, the document processing device 106, is to be added to the computer network 104, thereby enabling other devices 112, 114 and 116 to make use of the functions provided thereon, the document processing device 106 must be recognized by the computer network 104 as authorized to provide such functions. To state simply, the document processing device 106 must be recognized by the backend 102 so as to allow data communication with the network 104 via a suitable communications link 120. As will be appreciated by those skilled in the art, the communications link 120 is any means of communication between two electronic devices, including for example and without limitation, the Internet, an Ethernet based local area network or wide area network connection, an infrared connection, a Bluetooth connection, a Wi-Fi connection, an EEE 802.11(x) connection, a telephonic connection, a cellular based connection, and the like, or a combination thereof.

In operation, the technician 108 suitably installs or sets up the device 106 via any means known in the art. For example, when setting up a self-contained kiosk for performing document processing operations, the technician 108 must assemble the requisite components, ensure the proper connections and the like, before the device 106 is ready to perform document processing services. Once the device 106 has been suitably installed, the technician 108 contacts the backend to begin the initialization and connection process. Preferably, the technician 108 contacts the backend via the communications link 130. As will be understood by those skilled in the art, the communications link 130 suitably enables the two-way communication of voice and/or data between the technician 108 and the backend 102. The present invention employs a time-sensitive key, e.g., a password, transmitted to the technician 108 via the communications link 130 from the backend 102. It will be appreciated that the time-sensitive password is for illustration purposes only, and other types of restricted access keys are capable of being employed without departing from the scope of the present invention.

The technician 108 receives the time-sensitive key and inputs the key into the new network device 106, e.g., the document processing device. In one embodiment, the device 106 itself tests the key for validity against predefined standards preset in the device 106. In accordance with the present invention, the new device 106 first attempts to validate the input key to determine whether a predetermined period of time has elapsed prior to the input by the technician 108. As will be understood by those skilled in the art, suitable validation by the device 106 is accomplished using, for example and without limitation, an asymmetric corresponding algorithm as the backend 102. When the key is valid, the technician 108 then configures the new device 106 in accordance with instructions received from the backend 102, or alternatively, from instructions received from the device 106 manufacturer. It will be understood by those skilled in the art that the configuration instructions are capable of being received prior to setting up the device 106, as well as being received contemporaneously with the time-sensitive password. Once configured, the technician 108 advantageously instructs the device 106 to establish an initial session with the computer network 104 via the communications link 120. In one particular embodiment, once the technician 108 has input the time-sensitive password and configuration instructions, the device 106 suitably completes the connection without further input from the technician 108.

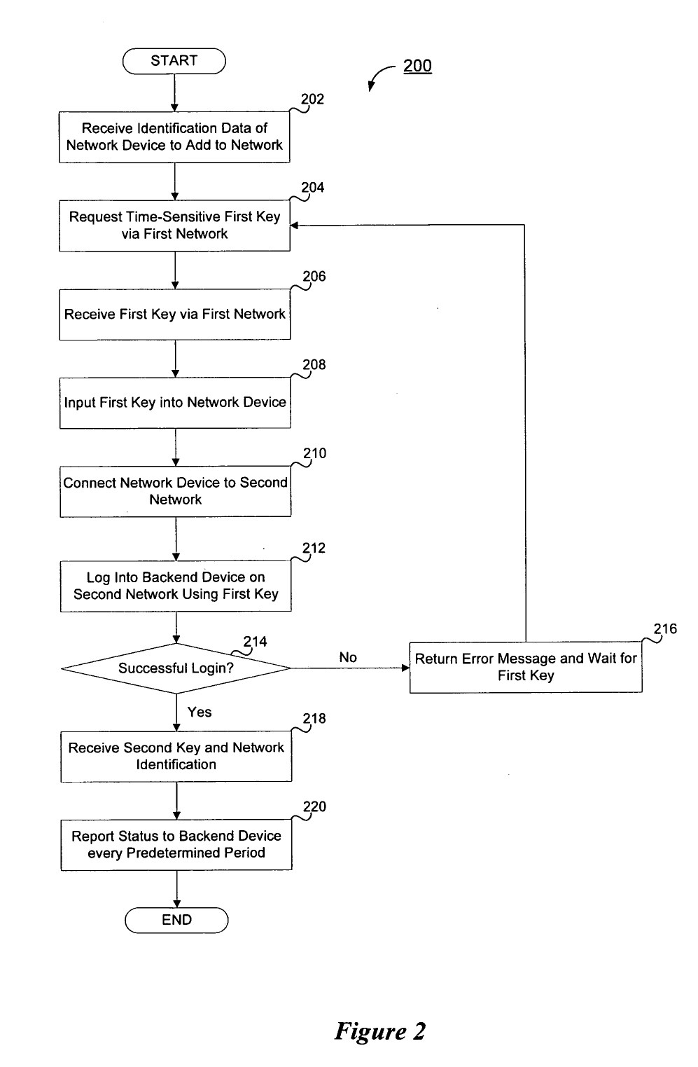

The new network device 106 then attempts to log into the backend 102 via the computer network 104. The device 106 transmits the time-sensitive password, device identification information, and a default key to the backend 102 for recognition. It will be understood by those skilled in the art that the device identification suitably includes a MAC address, device serial number, manufactured identification, or any other means of physically identifying the device 106 known in the art. Preferably, the default key is a factory or manufacturer set authentication key used to assist in the identification of the device 106. The backend 102 then processes the transmitted time-sensitive password, device identification and default key to generate a second authentication key and a network identification. The network identification and authentication key are then returned to the device 106. The device 106 is then recognized by the computer network 104 and is able to securely access the computer network 104 and provide document processing services to other devices connected thereto. Following secure connection to the computer network 104, the document processing device 106 periodically transmits status information to the backend 102 including data related to usage information, costs, and the like. It will be understood by those skilled in the art that the device 106 transmits, along with the status information, the authentication key and network identification. The foregoing system 100 will better be understood in conjunction with the method described in FIG. 2 below.

Referring now to FIG. 2, there is shown a flow chart 200 illustrating the secure recognition method in accordance with the present invention. Beginning at step 202, identification data is received corresponding to the device 106 to be added to the computer network 104. Preferably, the identification data corresponds to a device ID, serial number, manufacturer number, and the like. The skilled artisan will appreciate that the technician 108 suitably retrieves the identification data via any means known in the art. The technician 108 then contacts the backend 102 to request a time-sensitive first key via a first network at step 204. As will be understood by those skilled in the art, the first network is any suitable network of communications outside the firewall of the secure computer network 104. In the preferred embodiment, the technician 108 requests the time-sensitive first key via a voice-communication link 130 from the backend 102. The time-sensitive first key is then received over the first network at step 206.

The technician 108 then inputs the received time-sensitive first key into the network device 106 at step 208. At step 210, the network device is suitably connected to a second network, preferably the secure computer network 104. In the preferred embodiment, the device 106 first validates the input time-sensitive key using an asymmetric corresponding algorithm. Once connected, the device 106 then attempts to log into the backend 102 on the computer network 104 using the first time-sensitive key, device identification data, and a default factory set key. A determination is then made at step 214 to determine whether the login attempt is successful. When the login attempt is unsuccessful, flow proceeds to step 216, wherein an error message is returned to the technician 108 and the system waits for the proper first key. Following a predetermined period of time, flow proceeds to step 204 wherein the technician 108 is required to request a new time-sensitive key via the first network. It will be apparent to those skilled in the art that a variety of reasons are capable of causing the unsuccessful login attempt. For example and without limitation, the failure to login is capable of being attributed to the technician incorrectly inputting the time-sensitive key, the time-sensitive key has expired, and the like.

When the login attempt is successful, flow proceeds to step 218, wherein a second key and a network identification are received by the device 106. It will be understood by those skilled in the art that the network identification is capable of being network address, such as an IP address, an alphanumeric identification tag, and the like. Upon receipt of the second key and network identification, the device 106 is recognized by the computer network 104 and is securely connected to the network 104. It will also be understood by the skilled artisan that the device 106, having been securely recognized, is now able to send and receive data over the computer network 104 behind any security barriers existing thereon, including, without limitation, any security firewalls employed by the network 104. In the preferred embodiment, the communications between the device 106 and the computer network 104 are suitably encrypted using any data encryption means known in the art. Flow then proceeds to step 220, wherein the device 106 periodically reports its status to the backend 102. The skilled artisan will appreciate that the periodic reporting is suitably predetermined by the backend 102, a system administrator, the technician 108, or the like.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program, for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A system for the secure recognition of a network device comprising:
means adapted for receiving a first communication via a first communication network, the first communication inclusive of identification data representative of a network device to be added to a selected network;
means adapted for transmitting, responsive to the identification data, first data key associated with an initial login of the network device;
means adapted for entering the first data key in to the network device;
means adapted for validating identification data entered into the network device;
means adapted for connecting, upon validation of identification data, the network device so as to enable it for initial data communication via a second network;
means adapted for receiving into the network device, via the second network, a second data key; and
means adapted for enabling the network device for further data communication via the second network upon receipt of the second data key.

2. The system for the secure recognition of a network device of claim 1, further comprising:
means adapted for generating first key data inclusive of temporal limits for validity thereof; and
testing means adapted for testing the first key data for expiration of the temporal limits prior to the enablement of the network device for initial data communication via the second network.

3. The system for the secure recognition of a network device of claim 2 wherein the first communication network includes a verbal transmission of the identification data.

4. The system for the secure recognition of a network device of claim 3 wherein the first communication further includes identification of a requestor of the first data key.

5. The system for the secure recognition of a network device of claim 2 further comprising testing means adapted for testing, via the network device, the first key data prior to enabling the initial data communication via the second network.

6. The system for the secure recognition of a network device of claim 5, wherein the network device is one of the group consisting of a personal computer, a document processing device, a personal data assistant, and a laptop computer.

7. The system for the secure recognition of a network device of claim 6, wherein the network device is a document processing device and wherein the document processing device is located in a self-contained kiosk.

8. A method of secure recognition of a network device comprising the steps of:
receiving a first communication via a first communication network, the first communication inclusive of identification data representative of a network device to be added to a selected network;
transmitting, responsive to the identification data, first data key associated with an initial login of the network device;
entering the first data key in to the network device;
validating identification data entered into the network device;
upon validation of identification data, connecting the network device so as to enable it for initial data communication via a second network;
receiving into the network device, via the second network, a second data key; and
enabling the network device for further data communication via the second network upon receipt of the second data key.

9. The method of secure recognition of a network device of claim 8, further comprising the steps of:
generating first key data inclusive of temporal limits for validity thereof; and
testing the first key data for expiration of the temporal limits prior to enabling the network device for initial data communication via the second network.

10. The method of secure recognition of a network device of claim 9 wherein the first communication network includes a verbal transmission of the identification data.

11. The method of secure recognition of a network device of claim 10 wherein the first communication further includes identification of a requestor of the first data key.

12. The method of secure recognition of a network device of claim 9 further comprising the step of testing, via the network device, the first key data prior to enabling the initial data communication via the second network.

13. The method of secure recognition of a network device of claim 12, wherein the network device is one of the group consisting of a personal computer, a document processing device, a personal data assistant, and a laptop computer.

14. The method of secure recognition of a network device of claim 13, wherein the network device is a document processing device and wherein the document processing device is located in a self-contained kiosk.

15. A computer-readable medium of instructions with computer-readable instructions stored thereon for the secure recognition of a network device comprising:
instructions for receiving a first communication via a first communication network, the first communication inclusive of identification data representative of a network device to be added to a selected network;
instructions for transmitting, responsive to the identification data, first data key associated with an initial login of the network device;
instructions for entering the first data key in to the network device;
instructions for validating identification data entered into the network device;
instructions for upon validation of identification data, connecting the network device so as to enable it for initial data communication via a second network;
instructions for receiving into the network device, via the second network, a second data key; and
instructions for enabling the network device for further data communication via the second network upon receipt of the second data key.

16. The computer-readable medium of instructions with computer-readable instructions stored thereon for the secure recognition of a network device of claim 15, further comprising:
instructions for generating first key data inclusive of temporal limits for validity thereof; and
instructions for testing the first key data for expiration of the temporal limits prior to enabling the network device for initial data communication via the second network.

17. The computer-readable medium of instructions with computer-readable instructions stored thereon for the secure recognition of a network device of claim 16 wherein the first communication network includes a verbal transmission of the identification data.

18. The computer-readable medium of instructions with computer-readable instructions stored thereon for the secure recognition of a network device of claim 17 wherein the first communication further includes identification of a requestor of the first data key.

19. The computer-readable medium of instructions with computer-readable instructions stored thereon for the secure recognition of a network device of claim 16 further comprising instructions for testing, via the network device, the first key data prior to enabling the initial data communication via the second network.

20. The computer-readable medium of instructions with computer-readable instructions stored thereon for the secure recognition of a network device of claim 19, wherein the network device is one of the group consisting of a personal computer, a document processing device, a personal data assistant, and a laptop computer.

21. The computer-readable medium of instructions with computer-readable instructions stored thereon for the secure recognition of a network device of claim 20, wherein the network device is a document processing device and wherein the document processing device is located in a self-contained kiosk.

22. A computer-implemented method of secure recognition of a network device comprising the steps of:
receiving a first communication via a first communication network, the first communication inclusive of identification data representative of a network device to be added to a selected network;
transmitting, responsive to the identification data, first data key associated with an initial login of the network device;
entering the first data key in to the network device;
validating identification data entered into the network device;
upon validation of identification data, connecting the network device so as to enable it for initial data communication via a second network;
receiving into the network device, via the second network, a second data key; and
enabling the network device for further data communication via the second network upon receipt of the second data key.

23. The computer-implemented method of secure recognition of a network device of claim 22, further comprising the steps of:
generating first key data inclusive of temporal limits for validity thereof; and
testing the first key data for expiration of the temporal limits prior to enabling the network device for initial data communication via the second network.

24. The computer-implemented method of secure recognition of a network device of claim 23 wherein the first communication network includes a verbal transmission of the identification data.

25. The computer-implemented method of secure recognition of a network device of claim 24 wherein the first communication further includes identification of a requestor of the first data key.

26. The computer-implemented method of secure recognition of a network device of claim 23 further comprising the step of testing, via the network device, the first key data prior to enabling the initial data communication via the second network.

27. The computer-implemented method of secure recognition of a network device of claim 26, wherein the network device is one of the group consisting of a personal computer, a document processing device, a personal data assistant, and a laptop computer.

28. The computer-implemented method of secure recognition of a network device of claim 27, wherein the network device is a document processing device and wherein the document processing device is located in a self-contained kiosk.
